(19) United States
(12) Patent Application Publication
(10) Pub. No.: US 2019/0183288 A1
(43) Pub. Date: Jun. 20, 2019

(54) A COOKER

(71) Applicants: Phillip Brown, Brisbane, Queensland (AU); Robert John McLean, Coorparoo, Queensland (AU)

(72) Inventor: Robert John McLean, Coorparoo (AU)

(73) Assignee: Phillip Brown, Brisbane, Queensland (AU)

(21) Appl. No.: 16/326,153

(22) PCT Filed: Aug. 18, 2017
(86) PCT No.: PCT/AU2017/050881

§ 371 Date: Feb. 15, 2019

(30) Foreign Application Priority Data
Aug. 18, 2016 (AU) 2016903271

(51) Int. Cl. A47J 37/07; F23D 14/46; F23D 14/10

(52) U.S. Cl. CPC A47J 37/0713; F23D 14/46; F23D 2900/14641; A47J 37/0763; F23D 14/10

(57) ABSTRACT

The present invention relates to a cooker such as a barbeque. The cooker includes a support for supporting a cooking member such as a hotplate or grill. A burner is provided for being sheltered by the support and for burning gas to form flames. The burner is preferably sheltered by the support to impede dripping grease or fat, from the cooking member, from accumulating on the burners during cooking to thereby reduce cleaning when compared with known barbeques.

### TECHNICAL FIELD

The present invention generally relates to a cooker. The present invention has particular, although not exclusive application to a barbeque cooker.

### BACKGROUND

The reference to any prior art in this specification is not, and should not be taken as an acknowledgement or any form of suggestion that the prior art forms part of the common general knowledge.

A barbeque is an apparatus used to barbeque or grill food.

A known barbeque includes a cooking grill on which the food is cooked. Burners are located beneath the grill and burn gas to form flames that heat the grill. In practice, grease and fat from the cooking food passes over the burners and into a drip tray below.

The Applicant has perceived that is often awkward and difficult to clean accumulated grease and fat from the burners after cooking.

### SUMMARY OF THE INVENTION

According to one aspect of the present invention, there is provided a cooker including:

a support for supporting a cooking member; and

a burner for being sheltered by the support and for burning gas to form one or more flames.

Preferably, the burner is sheltered by the support to impede dripping grease or fat, from the cooking member, from accumulating on the burners during cooking to thereby reduce cleaning when compared with the known barbeque.

In one embodiment, the flames heat the cooking member. Alternatively, the flames impact charcoal in a charcoal tray. The gas flames may be extinguished once the charcoal is ignited so that charcoal flames instead heat the cooking member. The cooker may include a charcoal tray supported by the support. The charcoal tray may be removable. The charcoal tray may have at least one lip that engages with the support.

Preferably, the flames include jet flames. Preferably, the cooker is a barbeque. Preferably, the barbeque is portable. In one embodiment, the barbeque is fixed.

The flames may be directed horizontal or downwards. The burner may include distributed major ports from which major flames extend, and distributed minor ports interspersed between major ports from which minor flames extend. The burner may include an ignition at one end for igniting a flame which then serially lights the major and minor flames along the burner.

The burner may include a burner housing, and tubular outlets extending through the housing and defining the major ports. The burner may define gaps between the housing and outlets. The housing may define the minor ports. The burner may further include conduits for conveying gas into the housing. The conduits may be located between outlets.

The cooker may further include a gas supply manifold for supplying gas to the burner. The manifold may supply gas jets to the burner. The manifold may distribute gas to the burner at discrete and distributed points. The manifold may include injectors for injecting gas into respective outlets. The manifold may further include injectors for injecting gas into respective conduits. The barbeque may define gaps between the burner and gas supply manifold to facilitate mixing of air and gas. The burner and gas supply manifold may be elongate and extend in parallel. The cooker may include connectors for connecting the burner and gas supply manifold.

The support may define a channel. The support may be rectangular. The support may include stainless steel. The support may define tapering inner lips to facilitate burner sheltering. The cooker may include a tray holder for holding a tray beneath the cooking member. The cooker may include another burner spaced apart from the burner and configured so that the flames from both burners are directed toward each other. The flames from respective burners may form a gap.

The cooker may include an ignition bracket for holding an electrode. The cooker may include a thermocouple for measuring temperature. The cooking member may include a grill or a hot plate.

According to another aspect of the present invention, there is provided a cooker burner assembly including:

a burner for burning gas to form one or more flames; and

a gas supply manifold for supplying gas to the burner.

Preferably, the gas supply manifold is configured to distribute gas to the burner at discrete and distributed points. Preferably, the gas supply manifold supplies gas jets to the burner which forms jet flames.

According to another aspect of the present invention, there is provided a burner for a cooker, the burner configured to burn gas to form one or more jet flames.

According to another aspect of the present invention, there is provided a gas supply manifold for a cooker, the manifold configured to supply gas jets to the burner.

According to another aspect of the present invention, there is provided a cooker including:

a support for supporting a cooking member; and

a burner for burning gas to form one or more flames initially projected level or downward.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a side sectional view of a barbeque in accordance with an embodiment of the present invention;

FIG. 2 is a perspective view of a burner assembly of the barbeque of FIG. 1;

FIG. 3 is an exploded view of the burner assembly of FIG. 2;

FIG. 4a is a plan view of the burner assembly of FIG. 2;

FIG. 4b is a sectional view of the burner assembly of FIG. 2;

FIG. 5 shows sectional views of the burner assembly of FIG. 2;

FIG. 6 is a side sectional view of a coal barbeque in accordance with another embodiment of the present invention; and

FIG. 7 is a perspective view of the barbeque of FIG. 6.

### DETAILED DESCRIPTION OF PREFERRED EMBODIMENTS

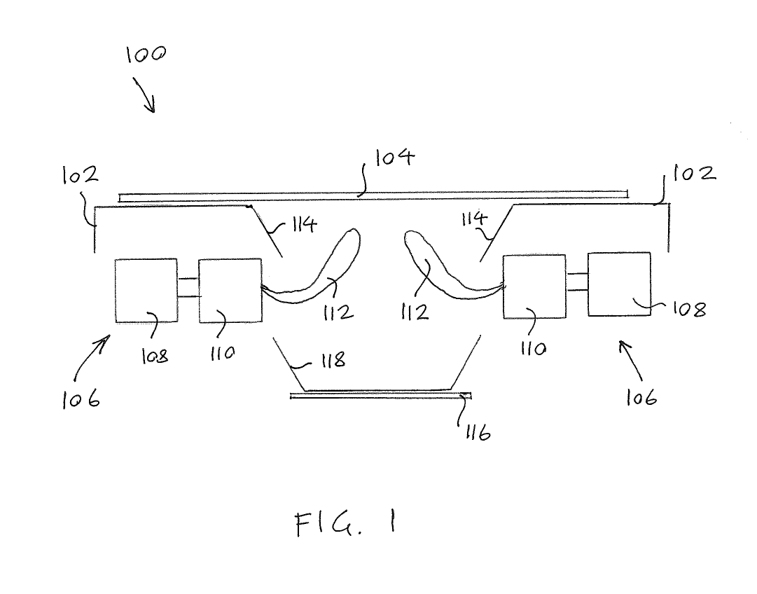

According to an embodiment of the present invention, there is provided a portable barbeque 100 (i.e. cooker) as shown in FIG. 1. The barbeque 100 includes a rectangular support 102 for supporting a cooking grill 104 (i.e. member). The barbeque 100 further includes a pair of lower burner assemblies 106.

Each burner assembly 106 includes a gas supply manifold 108 supplying gas to a jet burner 110. Each burner 110 is sheltered by the support 102 and burns the supplied gas to form flames 112 that heat the cooking grill 104. Advantageously, each burner 110 is sheltered by the support 102 to impede dripping grease and fat, from food on the grill 104, from accumulating on the burners 110 during cooking. Cleaning is thereby reduced when compared with known barbeques where grease and fat drip on the burners.

The support 102 defines an endless underside channel that may, at least in part, receive the lower burner assemblies 106. The support 102 is formed of bent stainless steel and may be glazed with glass. The support 102 defines tapering inner lips 114 to facilitate burner sheltering.

The barbeque 100 further includes a tray holder 116 for holding a disposable oil-collecting foil tray 118 beneath the grill 104. The jet flames 112 from both burners 110 are directed toward each other. The jet flames 112 are initially directed downwards and then curve upwards to form a gap. The heating of the grill 104 is quite consistent.

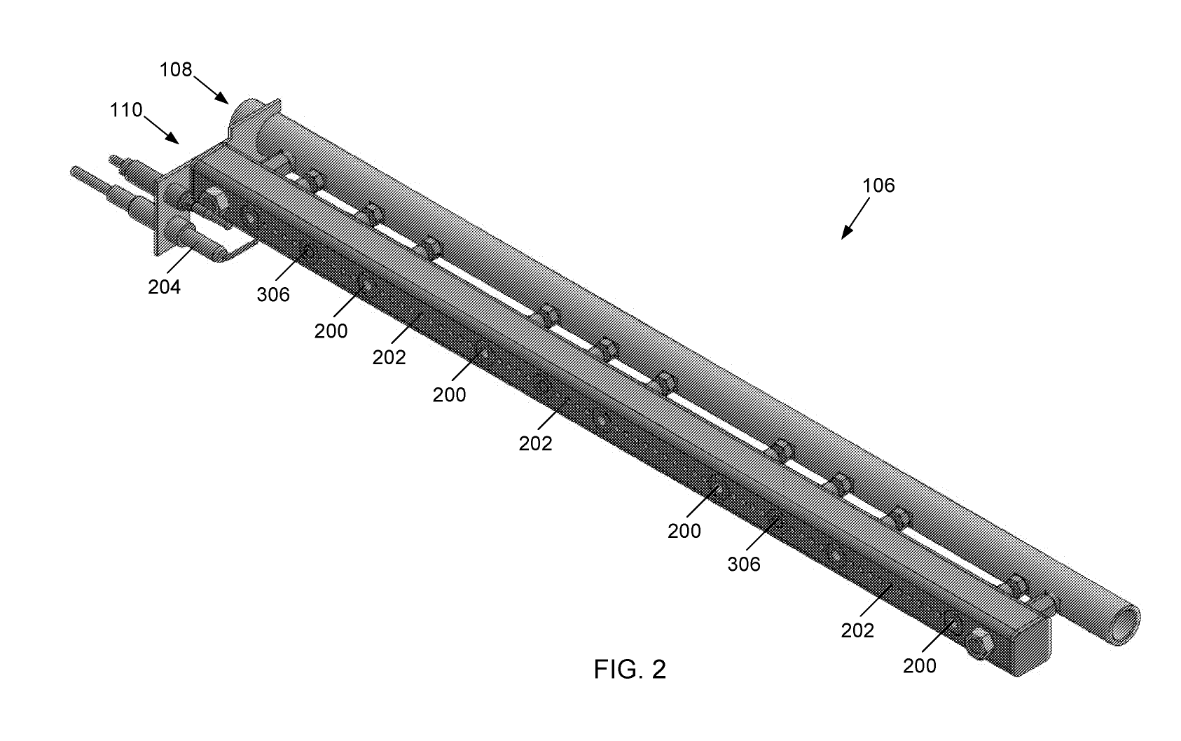

Turning to FIG. 2, the burner 110 includes distributed major ports 200 from which the major jet flames 112 extend. Distributed minor ports 202, from which minor flames extend, are interspersed between the major ports 200. The burner 110 also includes an ignition 204 at one end for igniting a flame, which then serially lights the major and minor flames along the burner 110.

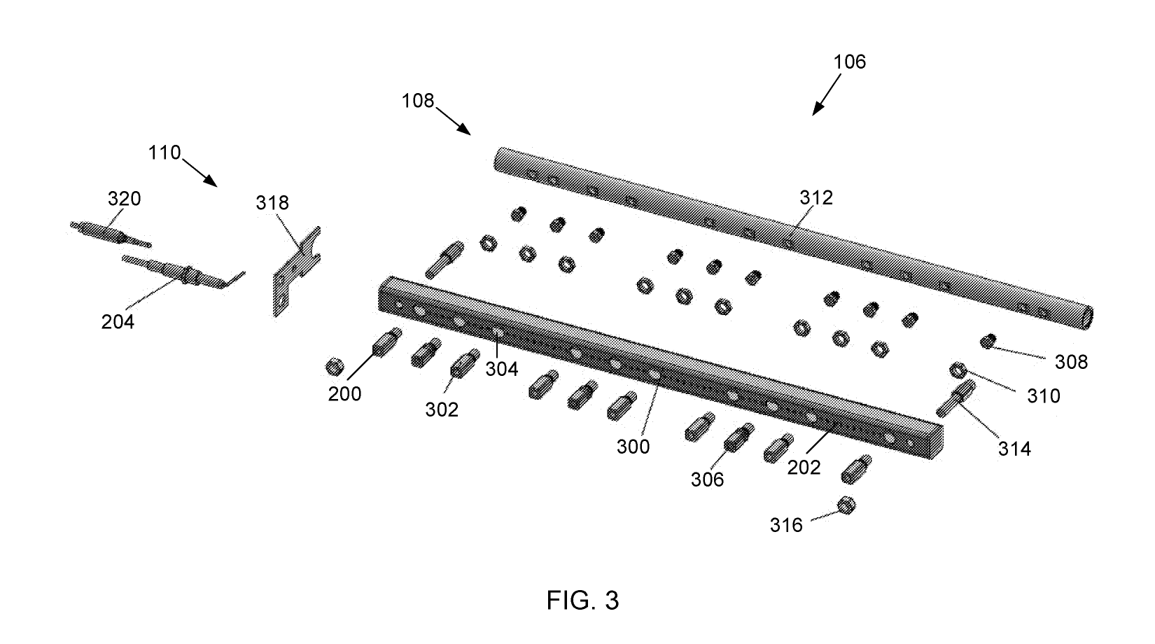

As can best be seen in FIG. 3, the burner 110 includes a tubular burner housing 300. Tubular Venturi outlets 302 extend through the housing 300 and define the major ports 200. The burner 110 defines flame bridging gaps between the housing 300 and tubes 302, when the square outlets 302 are inserted into corresponding round housing holes 304. The housing 300 defines the minor ports 202 and upon ignition, the flames creep along the minor ports 202 and gaps whilst lighting the major ports 200.

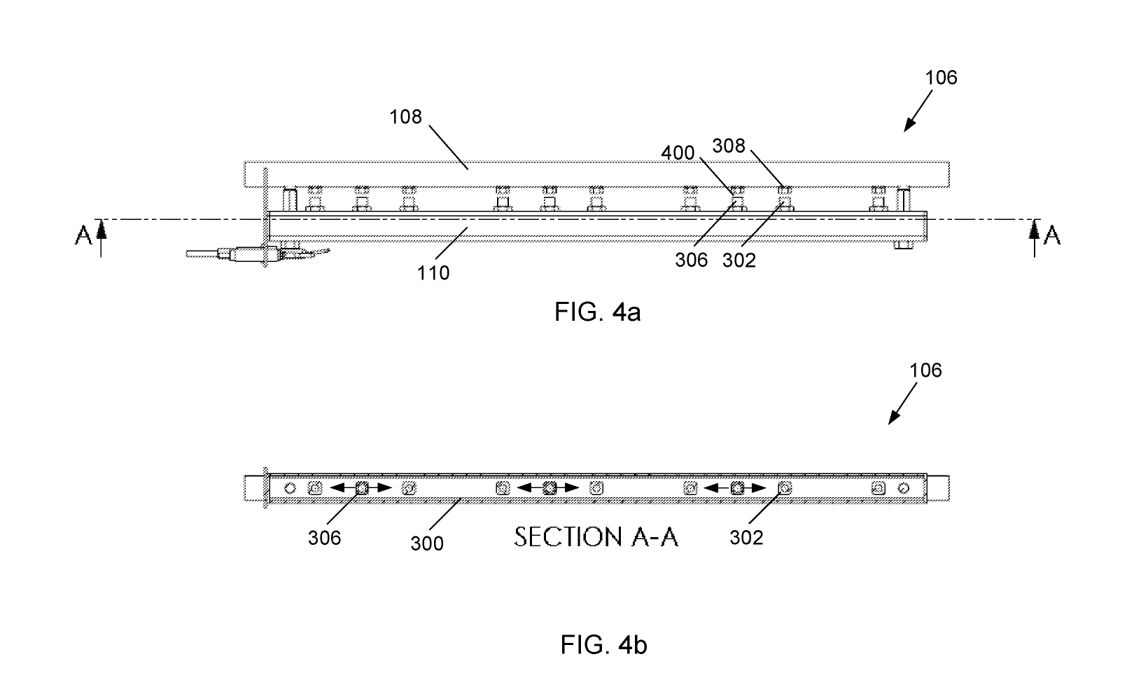

The burner 110 further includes tubular Venturi conduits 306 for conveying gas into the housing 300. The conduits 306 are located between outlets 302, and have a stopped free end and small lateral outlets through which the gas passes into the housing 300 (see FIG. 4b where arrows show internal gas flow). Once again, the burner 110 defines flame bridging gaps between the housing 300 and the conduits 306 when the square conduits 306 are inserted into corresponding round housing holes 304.

The gas supply manifold 108 supplies gas jets to the burner 110 at discrete and distributed points in register with the tubular Venturi outlets 302 and the tubular Venturi conduits 306. In this regard, the manifold 108 includes injectors 308, with securing nuts 310, for injecting gas into respective aligned outlets 302 and conduits 306. Each injector 308 is essentially a tube with a stopped free end defining a small outlet. The burner housing 300 and tubular manifold housing 312 are elongate and extend in parallel. The burner assembly 106 includes two end connectors 314, with fastening nuts 316, for connecting the burner 110 and gas supply manifold 108.

The burner assembly 106 includes an ignition bracket 318 for holding an electrode of the ignition 204. The bracket 318 also holds a thermocouple 320 for measuring temperature.

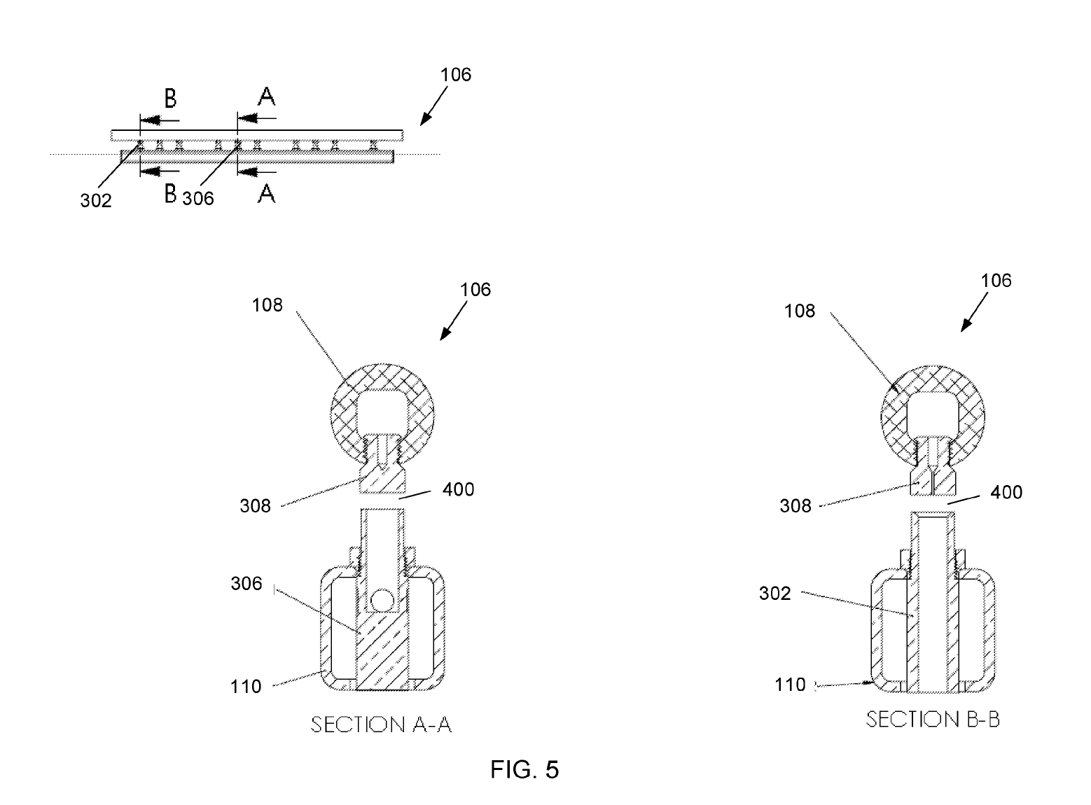

As can best be seen in FIG. 4a and FIG. 5, gaps 400 are formed between injectors 308 of the manifold 108 and the aligned outlets 302 and conduits 306 of the burner 110 to facilitate mixing of air and gas.

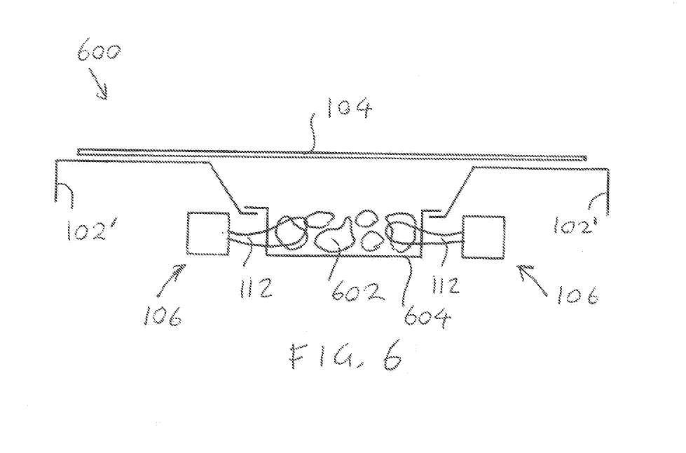

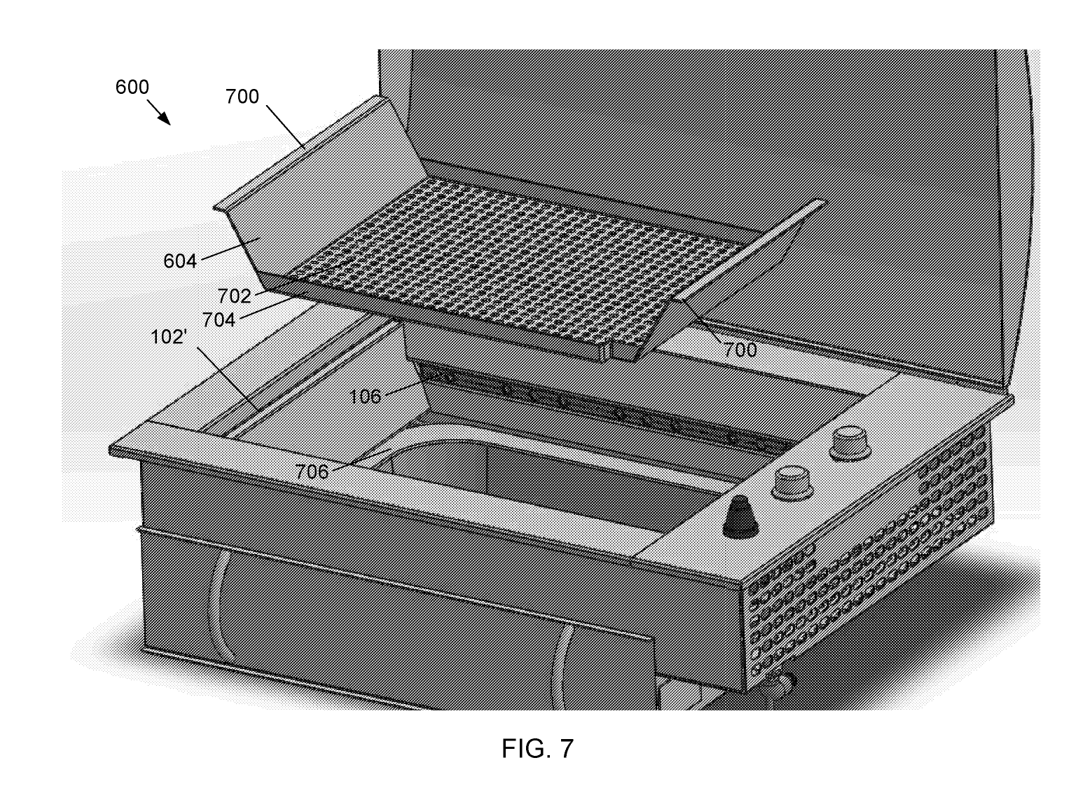

FIGS. 6 and 7 show a coal barbeque 600 in accordance with another embodiment of the present invention. Like reference numerals refer to like features previously described.

The flames 112 projecting from each burner assembly 106 impact charcoal 602 in a charcoal tray 604. The gas flames 112 can be turned off once the charcoal 602 is ignited so that charcoal flames instead heat the cooking member 104, or re-ignited to cook simultaneously with both gas and charcoal flames. The barbeque 600 includes the removable charcoal tray 604 that is supported by the support 102′, and which can be removed if not required so that only the gas flames 112 are used for cooking.

As can best be seen in FIG. 7, the charcoal tray 604 has lips 700 that engage with the support 102′. The tray 604 also has a permeable base 702 flanked by walls 704 to contain the coal 602. A drip tray 706 is located beneath the charcoal tray 604 which can be simply slid out for cleaning. As before, the gas flames 112 are initially directed level or slightly downward.

A person skilled in the art will appreciate that many embodiments and variations can be made without departing from the ambit of the present invention.

The grill 104 may be replaced by a solid hot plate. In one embodiment, the barbeque is fixed in a bench.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A cooker including:
a support for supporting a cooking member; and
a burner for being sheltered by the support and for burning gas to form one or more flames.

2. A cooker as claimed in claim 1, wherein the burner is sheltered by the support to impede dripping grease or fat, from the cooking member, from accumulating on the burner during cooking.

3. A cooker as claimed in claim 1, wherein the flames heat the cooking member.

4. A cooker as claimed in claim 1, wherein the flames impact charcoal in a charcoal tray.

5. A cooker as claimed in claim 4, wherein the gas flames can be turned off once the charcoal is ignited so that charcoal flames instead heat the cooking member, or the gas flames and charcoal flames can heat the cooking member simultaneously.

6. A cooker as claimed in claim 4, further including the charcoal tray supported by the support, the charcoal tray being removable and having at least one lip that engages with the support.

7. A cooker as claimed in claim 1, wherein the flames include jet flames that are initially directed level or downwards.

8. A cooker as claimed in claim 1, wherein the burner includes distributed major ports from which major flames extend, and distributed minor ports interspersed between major ports from which minor flames extend.

9. A cooker as claimed in claim 8, wherein the burner includes an ignition at one end for igniting a flame which then serially lights the major and minor flames along the burner.

10. A cooker as claimed in claim 8, wherein the burner includes a burner housing, and tubular outlets extending through the housing and defining the major ports.

11. A cooker as claimed in claim 10, wherein the burner defines gaps between the housing and outlets.

12. A cooker as claimed in claim 10, wherein the housing defines the minor ports and the burner further includes conduits for conveying gas into the housing, the conduits located between outlets.

13. A cooker as claimed in claim 1, further including a gas supply manifold for supplying gas to the burner.

14. A cooker as claimed in claim 13, wherein the manifold supplies gas jets to the burner at discrete and distributed points.

15. A cooker as claimed in claim 13, wherein the manifold includes injectors for injecting gas into respective outlets and conduits.

16. A cooker as claimed in claim 13, defining gaps between the burner and gas supply manifold to facilitate mixing of air and gas. The burner and gas supply manifold may be elongate and extend in parallel. The cooker may include connectors for connecting the burner and gas supply manifold.

17. A cooker as claimed in claim 1, further including another burner spaced apart from the burner and configured so that the flames from both burners are directed toward each other.

18. A cooker burner assembly including:
a burner for burning gas to form one or more flames; and
a gas supply manifold for supplying gas to the burner.

19. A burner for a cooker, the burner configured to burn gas to form one or more jet flames.

20. A gas supply manifold for a cooker, the manifold configured to supply gas jets to the burner.

21. A cooker including:
a support for supporting a cooking member; and
a burner for burning gas to form one or more flames initially directed level or downward.
